(19) United States
(12) Patent Application Publication
(10) Pub. No.: US 2016/0119874 A1
(43) Pub. Date: Apr. 28, 2016

(54) DETECTION OF SPURIOUS TCP CONTROL PACKETS

(71) Applicant: Qualcomm Innovation Center, Inc., San Diego, CA (US)

(72) Inventors: Sravan Kumar Ambapuram, Hyderabad (IN); Shirish Kumar Agarwal, Hyderabad (IN); Krishna V.S.S.S.R. Vanka, Hyderabad (IN); Vidula Rajeev Kurundkar, Hyderabad (IN); Thomas Matthew Rebman, Boulder, CO (US)

(21) Appl. No.: 14/524,555

(22) Filed: Oct. 27, 2014

(51) Int. Cl. H04W 52/02

(52) U.S. Cl. CPC H04W 52/0225; H04W 80/06

(57) ABSTRACT

Systems and methods for managing communications on a communication device are disclosed. A method may include receiving a communication packet at the communication device via a network connection and determining, at the communication device, whether the communication packet is an unsolicited control packet. Dormancy of the network connection is triggered after a first time period if the communication packet is not an unsolicited control packet, and dormancy of the network connection is triggered after a second time period if the communication packet is an unsolicited control packet wherein the second time period is less than the first time period.

### BACKGROUND

1. Field

The present invention relates generally to communications using transmission control protocol (TCP), and more specifically to detection of spurious TCP control packets.

2. Background

Transmission control protocol (TCP) is one of the core protocols of the Internet protocol suite (IP), and is so common that the entire suite is often called TCP/IP. TCP generally provides reliable, ordered and error-checked delivery of a stream of communications between programs running on computing devices connected to a local area network, intranet or the public Internet.

The protocol corresponds to the transport layer of TCP/IP suite. TCP provides a communication service at an intermediate level between an application program and the Internet Protocol (IP). That is, when an application program desires to send a large chunk of data across the Internet using IP, instead of breaking the data into IP-sized pieces and issuing a series of IP requests, the software can issue a single request to TCP and let TCP handle the IP details.

Due to network congestion, traffic load balancing, or other unpredictable network behavior, IP packets can be lost, duplicated, or delivered out of order. TCP detects these problems, requests retransmission of lost data, rearranges out-of-order data, and even helps minimize network congestion to reduce the occurrence of the other problems. Once the TCP receiver has reassembled the sequence of octets originally transmitted, it passes them to the receiving application. Thus, TCP abstracts the application's communication from the underlying networking details.

TCP is a reliable stream delivery service that guarantees that all bytes received will be identical with bytes sent and in the correct order. Since packet transfer over many networks is not reliable, a technique known as positive acknowledgment with retransmission is used to guarantee reliability of packet transfers. This fundamental technique requires the receiver to respond with an acknowledgment message as it receives the data. The sender keeps a record of each packet it sends. The sender also maintains a timer from when the packet was sent, and retransmits a packet if the timer expires before the message has been acknowledged. The timer is needed in case a packet gets lost or corrupted.

Although TCP is a pervasive, reliable delivery service, aspects of TCP may render a client device prone to exposure to spurious TCP control packets (e.g., SYN and FIN-ACK control packets) that impact device performance and cause battery drain. In current implementations, devices that receive spurious control packets are known to send a reset (RST) response, but sending a RST response consumes power. In addition, in current implementations these spurious control packets may prevent the client device from entering a dormancy mode because the client device is unable to distinguish the spurious control packets from data packets.

### SUMMARY

An aspect of the present disclosure may be characterized as a method for managing communications on a communication device. The method includes receiving a communication packet at the communication device via a network connection and determining whether the communication packet is an unsolicited control packet. The method also includes triggering, at the communication device, dormancy of the network connection after a first time period if the communication packet is not an unsolicited control packet, and triggering dormancy of the network connection of the communication device after a second time period if the communication packet is an unsolicited control packet wherein the second time period is less than the first time period.

Another aspect may be characterized as a communication device that includes a wireless transceiver to establish a network connection with a wireless telecommunications network, a modem coupled to the wireless transceiver to receive a communication packet via the network connection, and a control packet detection component that determines whether the communication packet is an unsolicited control packet. The communication device also includes a fast dormancy component that is configured to trigger dormancy of the network connection after a first time period if the communication packet is not an unsolicited control packet and trigger dormancy of the network connection of the communication device after a second time period if the communication packet is an unsolicited control packet wherein the second time period is less than the first time period.

Yet another aspect may be characterized as a non-transitory, tangible processor-readable storage medium, encoded with processor readable instructions to perform a method for managing communications on a communication device. The method includes receiving a communication packet at the communication device via a network connection, and determining whether the communication packet is an unsolicited control packet. The method also includes triggering dormancy of the network connection after a first time period if the communication packet is not an unsolicited control packet, and triggering dormancy of the network connection of the communication device after a second time period if the communication packet is an unsolicited control packet wherein the second time period is less than the first time period.

### BRIEF DESCRIPTION OF THE DRAWINGS

FIG. 1 is a block diagram depicting an embodiment of a communication device;

FIG. 2 is a flowchart depicting a method that may be traversed in connection with the embodiment depicted in FIG. 1;

FIG. 3 is a flowchart depicting another method that may be traversed in connection with the embodiment depicted in FIG. 1;

FIG. 4 is a flowchart depicting yet another method that may be carried out in connection with the embodiment depicted in FIG. 1;

FIG. 5 is a flowchart depicting another method that may be traversed in connection with the embodiment depicted in FIG. 1; and

FIG. 6 is a schematic diagram depicting physical components that may be utilized to realize the computing device depicted in FIG. 1.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any embodiment described herein as “exemplary” is not necessarily to be construed as preferred or advantageous over other embodiments.

The terms “mobile device,” “communication device,” and “mobile communication device” are used interchangeably herein to refer to any one or all of cellular telephones, smartphones, personal or mobile multi-media players, personal data assistants (PDA's), laptop computers, tablet computers, ultrabooks, palm-top computers, wireless electronic mail receivers, netbooks, multimedia Internet enabled cellular telephones, wireless gaming controllers, and similar personal electronic devices which include a programmable processor, a memory and circuitry for sending and/or receiving wireless communication signals via an open connection to a wireless network. While the various embodiments are particularly useful in mobile devices, such as cellular telephones, which have limited battery life, the embodiments are generally useful in any computing device that establishes communication sessions with a wireless telecommunication network.

The various embodiments presented throughout this disclosure may be implemented across a broad variety of telecommunication systems, network architectures, and communication standards. Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems. Generally, a wireless multiple-access communication system may simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

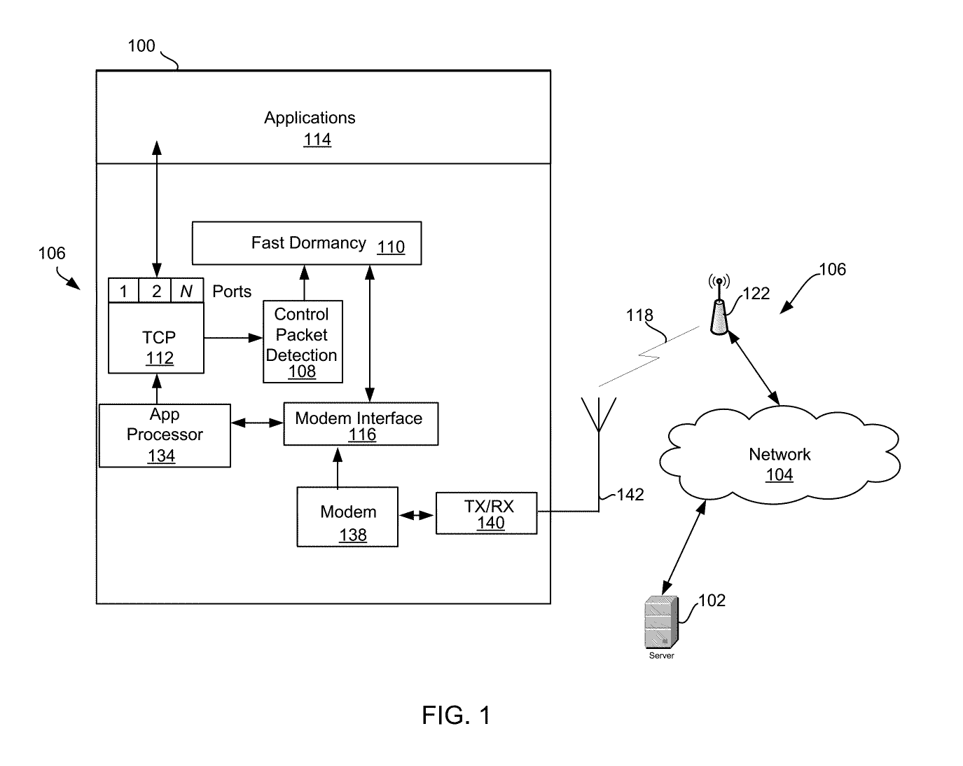

Referring to FIG. 1, it illustrates logical components and functional modules of a user equipment (UE) or mobile device 100 that receives services from a server 102 on a packet data network 104 via a wireless telecommunications network 106. In the embodiment illustrated in FIG. 1, a control packet detection component 108 is logically positioned between a fast dormancy controller 110 and a TCP stack 112. Associated with the TCP stack 112 are N ports that may be utilized to facilitate communications between applications 114 on the mobile device 100 and remote devices (e.g., the server 102). As depicted, the mobile device 100 may include a processing system that includes an application processor 134, and associated processor-readable media. The processing system may access a number of circuits of the mobile device 100, such as timing sources, peripherals, voltage regulators, and power management circuits. A modem interface 116 may provide an interface between an operating system and a modem 138, which includes a transceiver (transmitter/receiver (TX/RX)) 140 that use one or more antennas 142. The transceiver 140 enables wireless communication with the wireless telecommunication network 106. A user interface (e.g., keypad, display, speaker, microphone, joystick) may also be provided, and the mobile device 100 may include a portable source of power, such as a battery.

The fast dormancy controller 110 may monitor the network interactivity events of the applications 114 executing on the mobile device 100 to determine when a connection 118 should be released based on expiration of one or more device traffic inactivity timers. When the fast dormancy controller 110 determines that the connection 118 may be released, it may send a connection release message to a base node 122 of a radio access network (RAN) to close the connection 118. The connection release message may include a code, referred to as the “cause value” indicating the reason the connection is being released. For example, a signaling connection release indication (SCRI) message may be sent having a cause value of end of data transfer (EODT) meaning that the data transfer session has ended. The fast dormancy controller 110 may initiate transmission of an SCRI message based upon observed network interactivity on behalf of applications 114 to exercise fast dormancy. In this manner, the fast dormancy controller 110 can request release of a connection before a network inactivity timer initiates and without the need for any application fast dormancy requests.

As discussed above, the mobile device 100 is prone to receiving unsolicited TCP control packets that can adversely affect performance and the power draw of the mobile device 100. In prior implementations, regardless of the type of communication packet that was received, the prior versions of the fast dormancy controller 110 would use the same idle timer to trigger dormancy from the user equipment side. As a consequence, in these prior implementations, a network connection associated with an unsolicited communication packet would remain intact until the ordinary idle timer triggered dormancy; thus, unsolicited TCP control packets would cause performance degradation (due to network resources being utilized) and increased power consumption (due to the maintained network connection). Moreover, in prior implementations, in response to receiving unsolicited control packets, a reset (RST) message would be sent in response; thus further consuming power and creating network traffic.

In contrast, the control packet detection component 108 in this embodiment detects whether a received communication packet is an unsolicited control packet (e.g., a spurious TCP control packet), and if so, the control packet detection component 108 provides an indication to the fast dormancy controller 110 that an associated network connection for the control packet is unnecessary. In response, the fast dormancy controller 110 may trigger dormancy very quickly (e.g., less than two seconds). As discussed further herein, the fast dormancy controller 110 may employ a typical default timer to trigger dormancy under normal operation (e.g., when unsolicited control packets are not received), and may employ a second timer when unsolicited control packets are received. For example, the typical default timer may trigger dormancy after about twenty seconds and the second timer (started after unsolicited control packets are received) may trigger dormancy immediately or nearly immediately.

In many embodiments, the control packet detection component 108 is implemented at the kernel level. For example, the control packet detection component 108 may be realized by modifying the LINUX kernel to effectuate the functions described herein. In other embodiments, the control packet detection component 108 may be implemented in connection with hardware components (e.g., the modem 138) to analyze packets as they are received. Similarly, in some embodiments, the fast dormancy controller 110 may be implemented at the user level, but in other embodiments the fast dormancy controller 110 may be implemented at the kernel level.

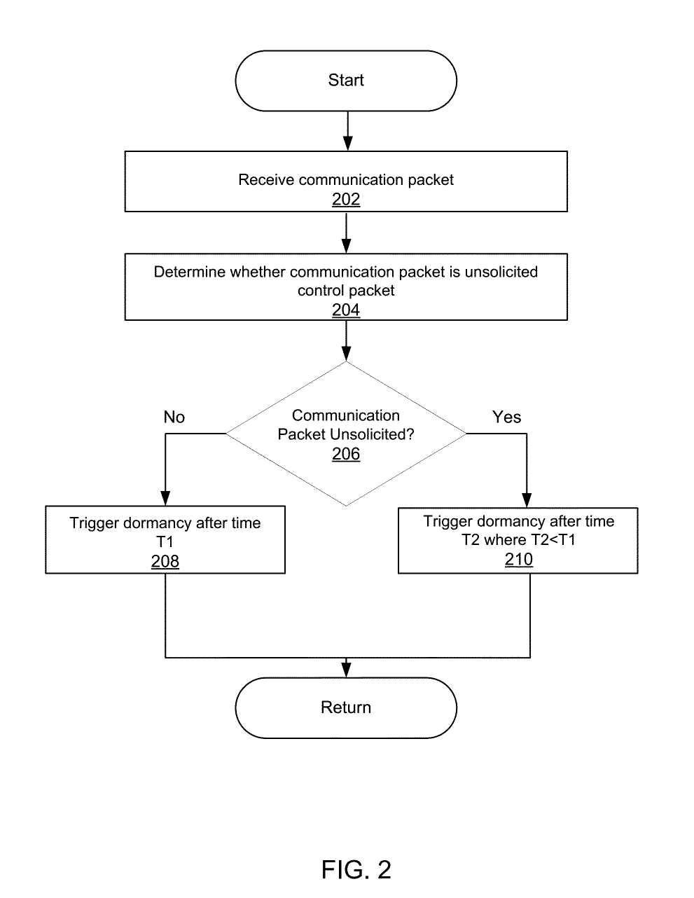

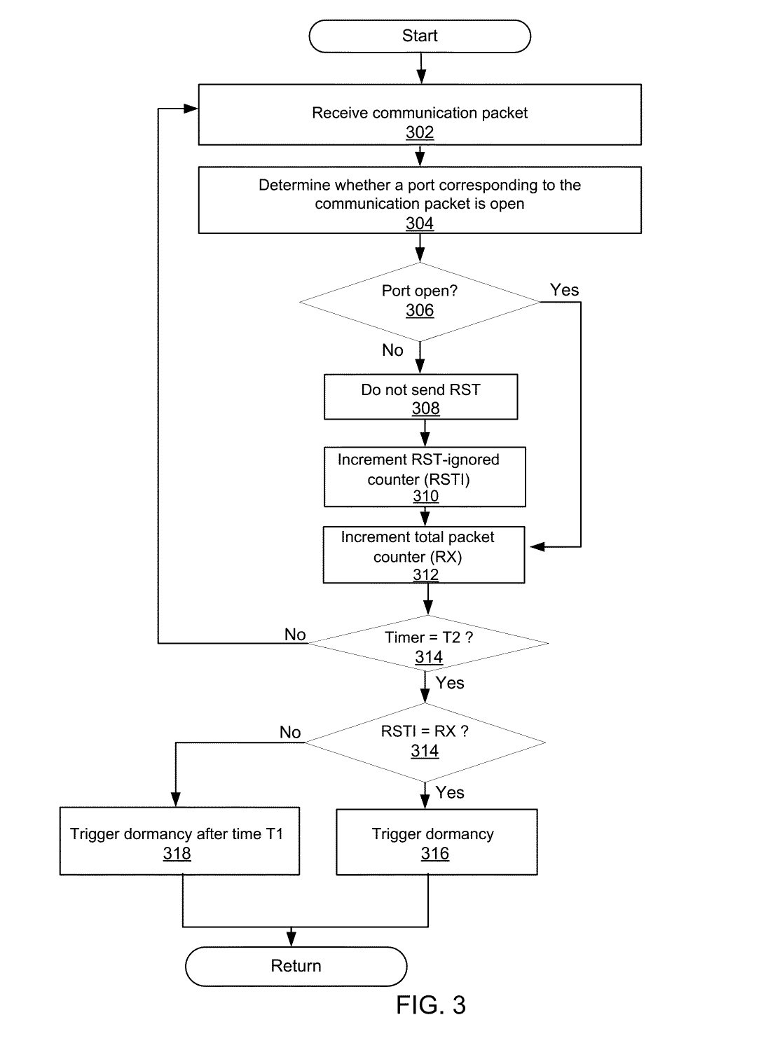

Referring next to FIG. 2, shown is a method that may be traversed in connection with the embodiment depicted in FIG. 1. As shown, when a communication packet is received at the mobile device 100 (Block 202), the control packet detection component 108 determines whether the communication packet is an unsolicited control packet (Block 204). Various methodologies discussed further in connection with FIGS. 3-5 may be utilized to determine whether the communication packet is an unsolicited control packet. As depicted, if the communication packet is not an unsolicited control packet (Block 206), the fast dormancy controller 110 initiates a first dormancy timer that triggers dormancy after a first time period T1 (Block 208). But if the communication packet is an unsolicited control packet (Block 206), the fast control packet detection component 108 prompts the fast dormancy controller 110 to trigger dormancy after a second time period T2, which is less than the first time period T1 (Block 210).

Referring next to FIG. 3, shown is another method that may be carried out in connection with the embodiment depicted in FIG. 1. In this method, all communication packets are counted over the second time period T2, and in addition, the number of unsolicited control packets that are received during the time period T2 are also counted, and if the number of control packets that are received is the same as the total number of packets, then dormancy is immediately triggered. More specifically, each time a communication packet is received (Block 302), a determination is made whether a port corresponding to the communication packet is listening for the communication packet (Block 304). If there is no port listening for the communication packet, then it is assumed that the communication packet is an unsolicited control packet, but unlike prior art implementations, no reset (RST) message is sent (Block 308). In other words, the control packet detection component 108 abstains from sending a reset message. In addition, an RST-ignored (RSTI) counter is incremented (Block 310), and a counter for the total number of received communication packets is also incremented (Block 312) until the time T2 has elapsed (Block 314). If after the time T2 has elapsed the number of RSTI packets is equal to the total number of received packets (Block 314), dormancy is triggered immediately (Block 316); otherwise dormancy is triggered after the first time period T1.

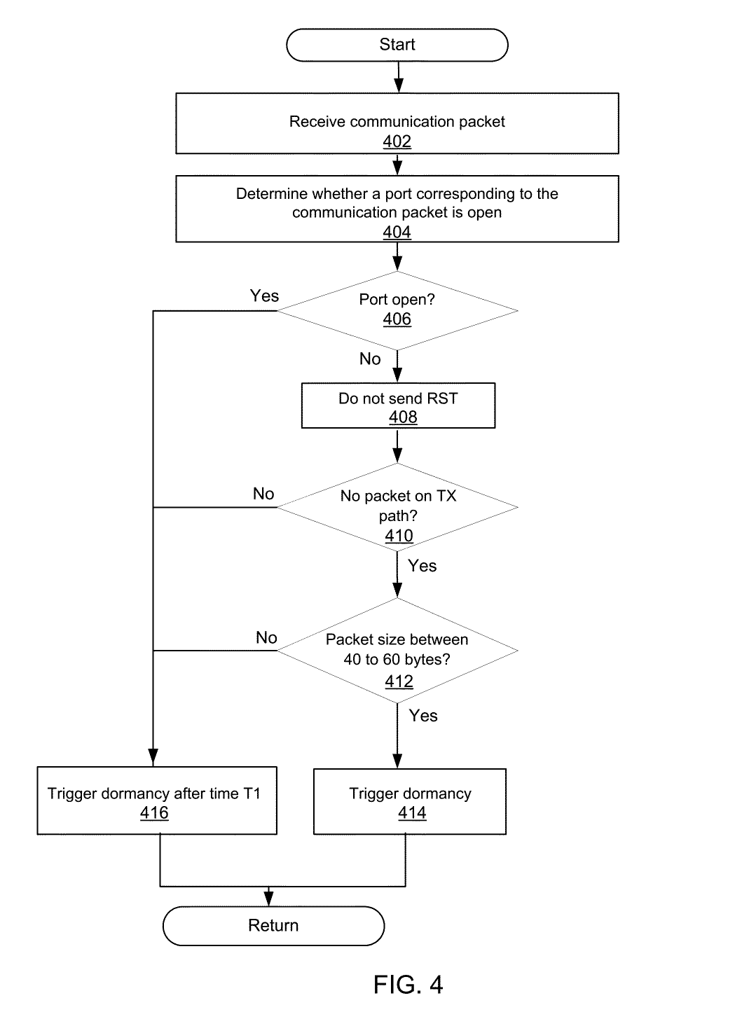

Referring next to FIG. 4, shown is yet another method that may be traversed in connection with the embodiment depicted in FIG. 1. As shown, when a communication packet is received (Block 402), a determination is made whether a port corresponding to the communication packet is open and listening for the communication packet (Block 404). If there is a port listening for the communication packet (Block 406), then an RST message is not sent from the mobile device 100. As shown, if there is not a packet on a transmit path (Block 410) and the packet size is between 40 to 60 bytes, then dormancy is triggered immediately (Block 414); otherwise, dormancy is triggered after time T1 (Block 416).

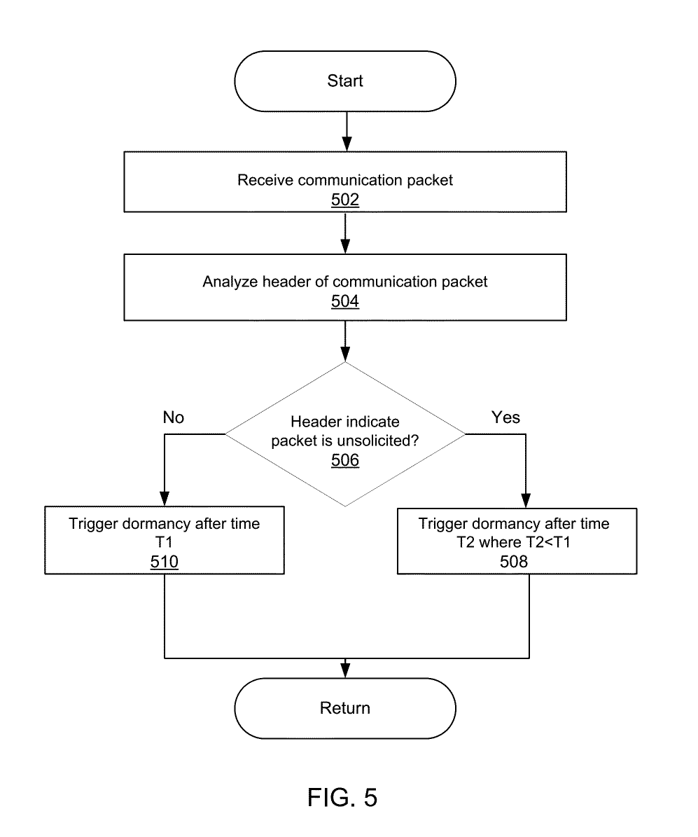

Referring next to FIG. 5 shown is another method that may be carried out according to other embodiments where a hardware device (e.g., modem 138 or application processor 134) determines whether the received communication packet is an unsolicited control packet. As shown, when a communication packet is received (Block 502), the header of the communication packet is read and analyzed to determine whether the communication packet is an unsolicited communication packet (Block 504). If the header indicates that the communication packet is unsolicited (Block 506), then dormancy is triggered after the second time period T2 (Block 508); otherwise, dormancy is triggered after the first time period T1.

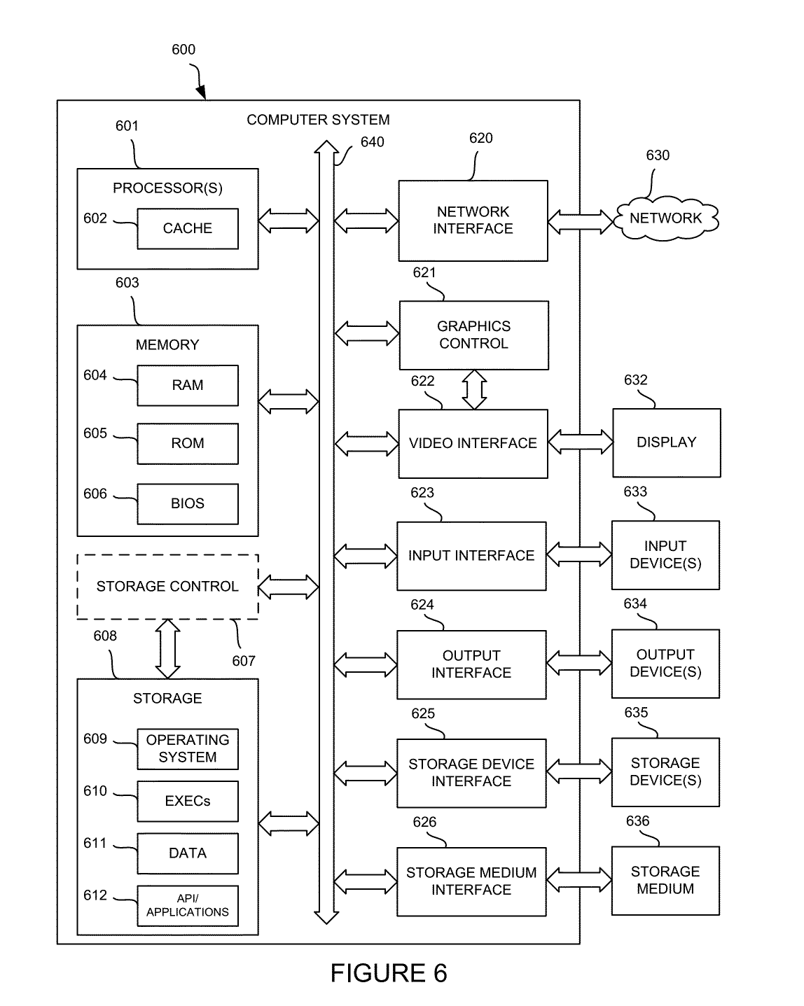

The systems and methods described herein can be implemented in a machine such as a computer system in addition to the specific physical devices described herein. FIG. 6 shows a diagrammatic representation of one embodiment of a machine in the exemplary form of a computer system 600 within which a set of instructions can execute for causing a device to perform or execute any one or more of the aspects and/or methodologies of the present disclosure. The components in FIG. 6 are examples only and do not limit the scope of use or functionality of any hardware, software, embedded logic component, or a combination of two or more such components implementing particular embodiments.

Computer system 600 may include a processor 601, a memory 603, and storage 608 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible, non-transitory, storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 601 (or central processing unit(s) (CPU(s))) optionally contains a cache memory unit 602 for temporary local storage of instructions, data, or computer addresses. Processor(s) 601 are configured to assist in execution of non-transitory, processor readable instructions (e.g., carry out the methods disclosed herein). Computer system 600 may provide functionality as a result of the processor(s) 601 executing software embodied in one or more tangible processor-readable storage media, such as memory 603, storage 608, storage devices 635, and/or storage medium 636. The processor-readable media may store software that implements particular embodiments, and processor(s) 601 may execute the software. Memory 603 may read the software from one or more other processor-readable media (such as mass storage device(s) 635, 636) or from one or more other sources through a suitable interface, such as network interface 620. The software may cause processor(s) 601 to carry out one or more processes or one or more steps of one or more processes described or illustrated herein. Carrying out such processes or steps may include defining data structures stored in memory 603 and modifying the data structures as directed by the software.

The memory 603 may include various components (e.g., machine readable media) including, but not limited to, a random access memory component (e.g., RAM 604) (e.g., a static RAM “SRAM”, a dynamic RAM “DRAM, etc.), a read-only component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 608 provides additional data storage capacity and may also include any suitable tangible computer-readable media described herein. Storage 608 may be used to store operating system 609, EXECs 610 (executables), data 611, APV applications 612 (application programs), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide nonvolatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, computer system 600 may include one or more other peripheral output devices 634 including, but not limited to, an audio speaker, a printer, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for managing communications on a communication device, the method comprising:
receiving a communication packet at the communication device via a network connection;
determining, at the communication device, whether the communication packet is an unsolicited control packet;
triggering, at the communication device, dormancy of the network connection after a first time period if the communication packet is not an unsolicited control packet; and
triggering, at the communication device, dormancy of the network connection of the communication device after a second time period if the communication packet is an unsolicited control packet wherein the second time period is less than the first time period.

2. The method of claim 1, wherein determining whether the communication packet is an unsolicited communication packet includes determining whether a port is listening for the communication packet.

3. The method of claim 2, wherein determining whether the communication packet is an unsolicited communication packet includes:
counting a total number of communication packets during the second time period;
abstaining from sending reset messages when no port is listening;
counting a number of packets received when no port is listening; and
determining the communication packet is unsolicited when the total number of communication packets is equal to the number of packets received when no port is listening.

4. The method of claim 1, wherein determining whether the communication packet is an unsolicited communication packet includes determining a size of the communication packet.

5. The method of claim 1, wherein determining whether the communication packet is an unsolicited communication packet includes reading a header of the communication packet to determine whether the communication packet is a control packet.

6. The method of claim 1 wherein the first time period is more than ten seconds and the second time period is less than two seconds.

7. The method of claim 1, wherein no reset (RST) response is sent if the communication packet is an unsolicited control packet.

8. A communication device comprising:
a wireless transceiver to establish a network connection with a wireless telecommunications network;
a modem coupled to the wireless transceiver to receive a communication packet via the network connection;
a control packet detection component that determines whether the communication packet is an unsolicited control packet;
a fast dormancy component that is configured to:
trigger dormancy of the network connection after a first time period if the communication packet is not an unsolicited control packet; and
trigger dormancy of the network connection of the communication device after a second time period if the communication packet is an unsolicited control packet wherein the second time period is less than the first time period.

9. The communication device of claim 8, wherein the control packet detection component determines whether the communication packet is an unsolicited communication packet by determining whether a port is listening for the communication packet.

10. The communication device of claim 9, wherein the control packet detection component is configured to:
count a total number of communication packets during the second time period;
abstain from sending reset messages when no port is listening;
count a number of packets received when no port is listening; and
determine the communication packet is unsolicited when the total number of communication packets is equal to the number of packets received when no port is listening.

11. The communication device of claim 8, wherein the control packet detection component is configured to:
determine whether the communication packet is an unsolicited communication packet by determining a size of the communication packet.

12. The communication device of claim 8, wherein the control packet detection component is implemented in one of the modem or an application processor, and the control packet detection component determines the communication packet is an unsolicited communication packet by reading a header of the communication packet to determine whether the communication packet is a control packet.

13. A non-transitory, tangible processor-readable storage medium, encoded with processor readable instructions to perform a method for managing communications on a communication device, the method comprising:
receiving a communication packet at the communication device via a network connection;
determining, at the communication device, whether the communication packet is an unsolicited control packet;
triggering, at the communication device, dormancy of the network connection after a first time period if the communication packet is not an unsolicited control packet; and
triggering, at the communication device, dormancy of the network connection of the communication device after a second time period if the communication packet is an unsolicited control packet wherein the second time period is less than the first time period.

14. The non-transitory, tangible processor-readable storage medium of claim 13, wherein determining whether the communication packet is an unsolicited communication packet includes determining whether a port is listening for the communication packet.

15. The non-transitory, tangible processor-readable storage medium of claim 14, wherein determining whether the communication packet is an unsolicited communication packet includes:
counting a total number of communication packets during the second time period;
abstaining from sending reset messages when no port is listening;
counting a number of packets received when no port is listening; and
determining the communication packet is unsolicited when the total number of communication packets is equal to the number of packets received when no port is listening.

16. The non-transitory, tangible processor-readable storage medium of claim 13, wherein determining whether the communication packet is an unsolicited communication packet includes determining a size of the communication packet.

17. The non-transitory, tangible processor-readable storage medium of claim 13, wherein determining whether the communication packet is an unsolicited communication packet includes reading a header of the communication packet to determine whether the communication packet is a control packet.

18. The non-transitory, tangible processor-readable storage medium of claim 13 wherein the first time period is more than ten seconds and the second time period is less than two seconds.

19. The non-transitory, tangible processor-readable storage medium of claim 13, wherein no reset (RST) response is sent if the communication packet is an unsolicited control packet.
